(19) United States
(12) Patent Application Publication
(10) Pub. No.: US 2004/0047595 A1
(43) Pub. Date: Mar. 11, 2004

(54) Recording apparatus and computer-readable program

(76) Inventors: Yasuyuki Matsuura, Higashihiroshima-shi (JP); Masahiro Horie, Kuga-gin (JP)

Correspondence Address: WENDEROTH, LIND & PONACK, L.L.P., 2033 K STREET N. W., SUITE 800, WASHINGTON, DC, 20006-1021, US

(21) Appl. No.: 10/602,882

(22) Filed: Jun. 25, 2003

(30) Foreign Application Priority Data
Jul. 31, 2002 (JP) 2002-222525

(51) Int. Cl. H04N 5/91

(52) U.S. Cl. 386/67

(57) ABSTRACT

The continuous recording controlling unit 10 performs the continuous recording process and stores VOBUs broadcasted from N hours ago to the current time in the HDD 5. The recording apparatus receives a specification from the user as to which period of the recording between N hours ago and the current time should be retained. The protective attribute setting unit 13 sets a protective attribute to a part of the HDD 5 that corresponds to the period specified by the user. The continuous recording process is performed by overwriting one of the VOBUs recorded on the HDD 5 with a newly obtained VOBU, but the part of the HDD 5 to which the protective attribute is set is protected against overwriting.

### BACKGROUND OF THE INVENTION

1. Field of the Invention

The present invention relates to recording apparatuses that perform recording process of broadcast.

2. Description of the Related Art

These days various broadcast services are offered through ground waves and satellite waves. The broadcast schedules are available to the general public in the TV sections of magazines and newspapers and EPGs (Electric Program Guides). In order for a user to watch a broadcast program that he/she wishes to see, the user needs to look for the broadcast program in the TV section of a magazine/newspaper or an EPG, and complete either programming or operating of the recording apparatus before the broadcast program starts.

When users do not have enough time to look at the TV section of a magazine/newspaper or an EPG, they will not be able to program or operate the recording apparatus. Some users may be disappointed to learn that they missed a broadcast program that they would have liked to see.

### SUMMARY OF THE INVENTION

The object of the present invention is to provide a recording apparatus that is able to retain a broadcast program even when the user is not able to program or operate the recording apparatus before the broadcast program starts.

In order to achieve the object, the present invention provides a recording apparatus comprising: a continuous recording unit operable to perform continuous recording and obtain broadcast contents broadcasted from N hours ago to a current time onto a recording medium; and a setting unit operable to set a protective attribute onto a part of the recording medium according to a user operation, wherein the broadcast contents are made up of a plurality of video units, the continuous recording unit performs the continuous recording by (i) receiving a broadcast wave to obtain a new video unit, and (ii) overwriting one of the video units with the new video unit, and the part of the recording medium having the protective attribute is protected against the overwriting performed by the continuous recording unit.

With this arrangement, the recording medium stores broadcast programs broadcasted from N hours ago to the current time recorded by the continuous recording unit. Because the broadcast programs recorded onto the recorded medium are retained without being overwritten until N hours of time elapses after the broadcast begins, even if a user misses an opportunity to operate to record a broadcast program, he/she is still able to make a specification even after the broadcast program has started. Since the specification of retaining the broadcast program can be made after the broadcast of the program has started, and the user has time of N hours to make the specification, the possibility for the user to be able to view the broadcast program will be higher.

The recording apparatus may have an arrangement wherein the part of the recording medium having the protective attribute stores therein two or more video units which represent one of a plurality of broadcast programs that have been broadcasted between N hours ago and the current time, the recording apparatus further comprises a display unit operable to display a schedule table of the plurality of broadcast programs, and the user operation specifies a period during which the one of the plurality of broadcast programs is being broadcasted.

With this arrangement, the recording apparatus receives a specification from a user as to which period of recording should be retained in terms of a program schedule, with which users are more familiar; therefore, it is convenient for the users.

The recording apparatus may have an arrangement wherein the part of the recording medium having the protective attribute corresponds to a period, the period being a part of duration between N hours ago and the current time, and the user operation is an input of a starting time and an ending time of the period.

With this arrangement, the user is able to specify a period for which the recording should be retained with reference to the TV section of a newspaper or a magazine; therefore, it is convenient for the users.

The recording apparatus may have an arrangement wherein the user operation is an input of a starting time, and the part of the recording medium having the protective attribute stores therein two or more video units which correspond to either (a) a predetermined length of time beginning at the starting time or (b) a predetermined length of time into past from the starting time.

With this arrangement, the user is able to specify a period for which the recording should be retained only by inputting the starting time of the period; therefore, the user is able to operate with more facility.

The recording apparatus may further comprise: a loading unit operable to load a portable recording medium; and a copying unit operable to copy, onto the portable recording medium, the part of the recording medium having the protective attribute.

With this arrangement, the part to which the protective attribute is set will be recorded onto both “the recording medium” and “the portable recording medium”. Since the part with the protective attribute will be retained on these recording media, the user is able to reproduce the recording with more facility.

The recording apparatus may have an arrangement wherein the part of the recording medium keeps having the protective attribute thereon until the part finishes being copied onto the portable recording medium, at which time the protective attribute gets cancelled.

With this arrangement, the protective attribute set to a broadcast program gets cancelled on the condition that the copying from the recording medium to the portable recording medium is completed; therefore, it is possible to alleviate excessive occupancy in the recording medium by the part having the protective attribute set thereto.

### BRIEF DESCRIPTION OF THE DRAWINGS

These and the other objects, advantages and features of the invention will become apparent from the following description there of taken in conjunction with the accompanying drawings which illustrate a specific embodiment of the invention.

In the drawings:

FIG. 1 shows a mode of using the recording apparatus of the present invention;

FIG. 2 is a diagram to show the internal structure of the recording apparatus;

FIGS. 3A through 3D show the typical recording process performed by the continuous recording controlling unit 10;

FIGS. 4A through 4C show the typical recording process performed by the continuous recording controlling unit 10;

FIG. 5 is an example of a menu for receiving inputs from a user as to a starting time and an ending time of a protective attribute;

FIG. 6 is a flow chart showing the procedure in the process performed by the continuous recording controlling unit 10;

FIGS. 7A through 7C illustrate a VOBU writing in a case where a WP is located before the end of the HD area and also the address after adding the VOBU size to the WP is still located be-fore the end of the HD area;

FIGS. 8A through 8C illustrate a VOBU writing in a case where a WP has reached the end of the HD area;

FIGS. 9A through 9D illustrate a VOBU writing in a case where a WP is near the end of the HD area;

FIGS. 10A and 10B illustrate a VOBU writing in a case where a WP is located before the start of the protected area i and also the address after adding the VOBU size to the WP is still located before the start of the protected area i;

FIGS. 11A through 11C illustrate a VOBU writing in a case where a WP has reached the start of the protected area;

FIGS. 12A through 12D illustrate a VOBU writing in a case where a WP has not reached the start of the protected area but the distance to the start of the protected area is too short to write the whole VOBU thereto;

FIGS. 13A through 13D illustrate how continuous recording is performed when Content A, Content B, and Content C have already been written to the HD area, and the writing of Content D is under way;

FIGS. 14A through 14D illustrate the subsequent process to the one shown in FIGS. 13A through 13D;

FIG. 15is a flow chart showing the procedure in the process performed by the protective attribute setting unit 13;

FIG. 16is a flowchart showing the procedure in the process for converting the starting and ending points inputted by the user to addresses on the HD area;

FIGS. 17A through 17D show specific examples to explain in detail the flow chart in FIG. 16;

FIG. 18 is a flowchart showing the procedure in the process performed by the reproduction controlling unit 11 and the protective attribute setting unit 13 in the second embodiment; and

FIG. 19 is a diagram to show the internal structure of a recording apparatus called a hybrid recorder.

### DESCRIPTION OF THE PREFERRED EMBODIMENTS

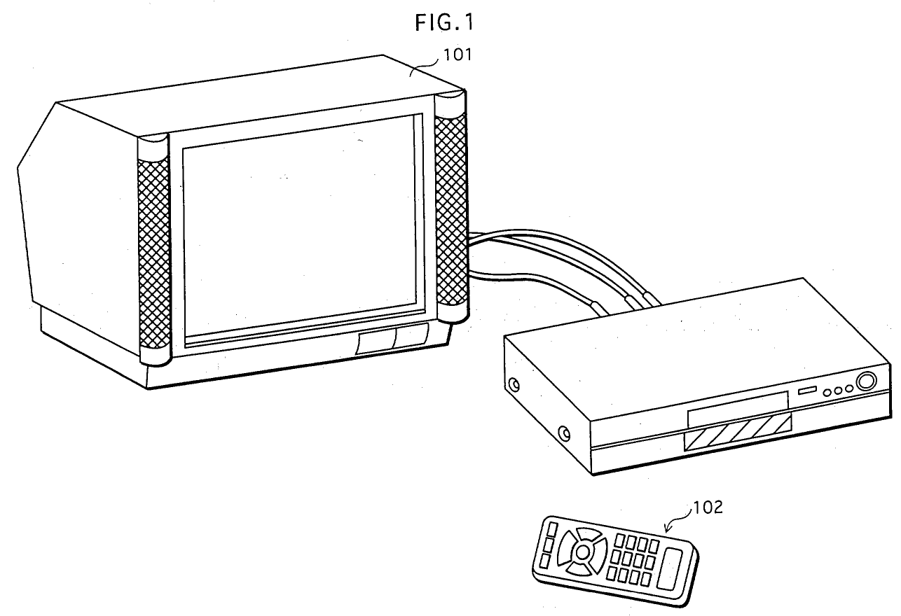

The following describes embodiments of the recording apparatus of the present invention. Firstly, among different actions related to the apparatus, a mode of using the recording apparatus of the present invention will be explained. As shown in FIG. 1, the recording apparatus of the present invention, as well as a TV 101 and a remote controller 102, is part of a home server system and serves the purpose of performing continuous recording of the broadcast to be displayed on the TV 101.

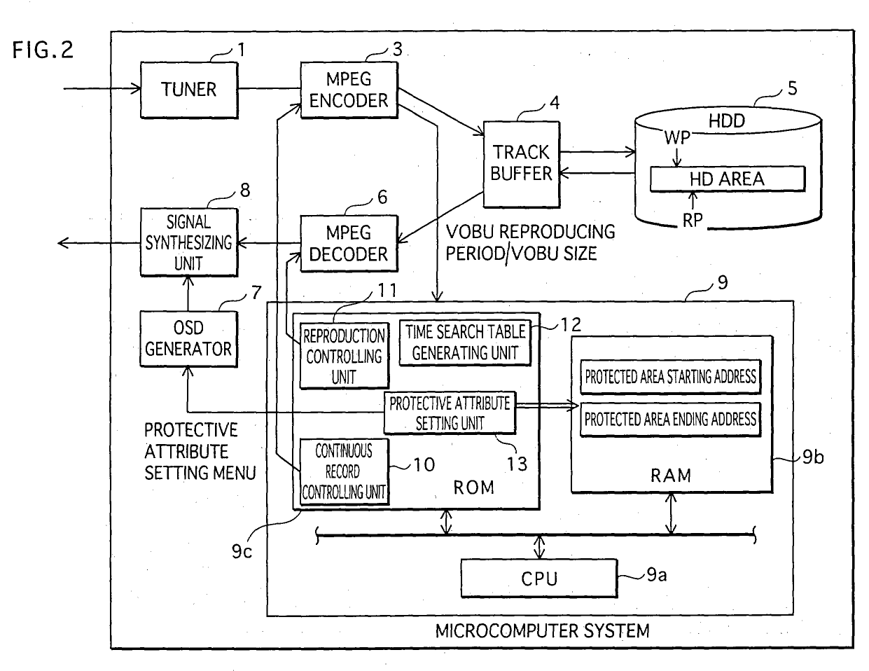

Secondly, among different actions related to the recording apparatus of the present invention, a mode of manufacturing the apparatus will be explained. The recording apparatus of the present invention can be industrially manufactured on the basis of the internal structure shown in FIG. 2. FIG. 2 is a diagram showing the internal structure of the recording apparatus. As shown in FIG. 2, the recording apparatus comprises hardware resources including a tuner 1, an MPEG encoder 3, a track buffer 4, an HDD 5, an MPEG decoder 6, an OSD generator 7, a signal synthesizing unit 8, and a microcomputer system 9.

The tuner 1 demodulates, out of TV broadcast waves, certain broadcast signals on a channel selected by the user, and outputs picture signals and audio signals to the MPEG encoder 3.

The MPEG encoder 3 generates VOBUs (Video Object Units) as per the DVD-Video Recording Standard by encoding analog video signals and analogue audio signals. A VOBU is a smallest decodable unit that includes (i) a GOP (Group of Pictures) which is a collection of pieces of 0.4 to 1.0 second-long picture data and (ii) audio frames to be reproduced concurrently with such a GOP. VOBUs correspond with pieces of broadcast data. A method called VBR (Variable Bit Rate) is used for the encoding of the analog video signals. In the VBR method, the bit rate assignment is set at high for signal intervals in the analog video signals when they are for complicated images. Conversely, the bit rate assignment is set at low for signal intervals when they are for simple images. With such adjustments, it is possible to have a bit rate average of a certain value, and thus to avoid variations in image quality.

The track buffer 4 temporarily stores the VOBU generated by the MPEG encoder 3, and outputs it to the HDD 5. At times of reproduction, the track buffer 4 temporarily stores the VOBU read from the HDD 5, and outputs it to the MPEG decoder 6.

The HDD (HD Drive) 5 has an HD area and performs the reading and writing of VOBUs from and to the HD area. The HD area has a capacity in which N-hour-long VOBUs can be written.

The MPEG decoder 6 decodes the VOBUs read from the MPEG encoder 3 so as to obtain analogue video signals and audio signals.

The OSD generator 7 generates an OSD (On Screen Display) and outputs it to the signal synthesizing unit 8 so that the OSD gets synthesized with the picture data. The OSD is for drawing a menu which can be changed according to the user operation and provides a GUI for the user.

The signal synthesizing unit 8 synthesizes the picture data with the OSD by combining horizontal lines forming the uncompressed picture data and horizontal lines of the OSD, and converts the result to picture signals for a TV. When combining these horizontal lines, the signal synthesizing unit 8 is able to adjust the combining ratios so as to, for example, cover and hide the picture data with the OSD, or have the picture data seen through the OSD.

The microcomputer system 9 comprises the CPU 9a, the RAM 9b, and the command ROM 9c, and has systematic control over the recording apparatus by having the CPU 9a execute a computer program stored in the command ROM 9c. The command ROM 9c pre-stores the computer program. The computer program functions as achieving means such as the continuous recording controlling unit 10, the reproduction controlling unit 11, the time search table generating unit 12, and the protective attribute setting unit 13, in collaboration with the hardware resources constituting the microcomputer system 9.

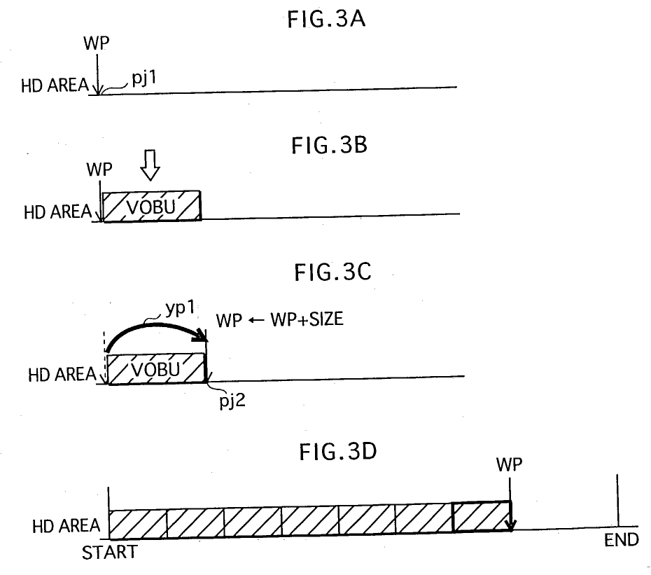

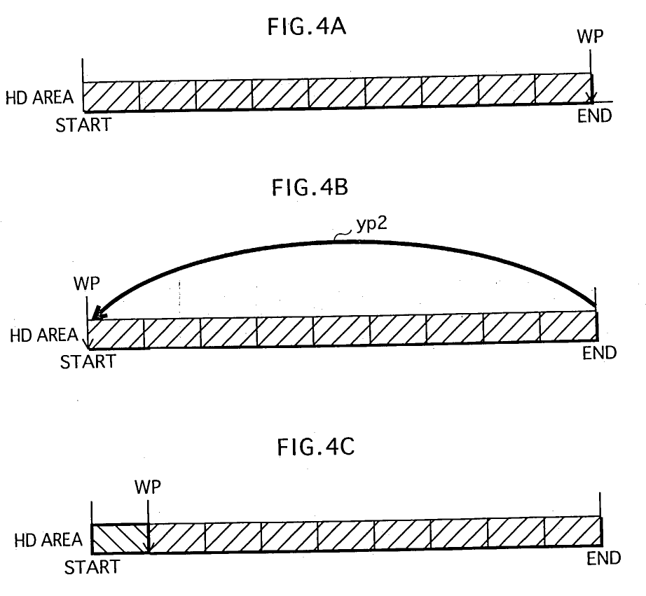

The continuous recording controlling unit 10 controls the MPEG encoder 3 and the HDD 5 to perform the recording process. The recording process is to write a VOBU to an area located after a writing pointer (referred to as WP) within the HD area every time a VOBU is stored in the track buffer 4, and subsequently advance the location of the WP by the size of the VOBU. FIGS. 3A through 3D and 4A through 4C show the typical recording process performed by the continuous recording controlling unit 10. The WP is set at the location pj1 in FIG. 3A. When a VOBU is stored in the track buffer 4, the VOBU gets written to the area located after the WP as shown in FIG. 3B, and subsequently the WP gets shifted to the location pj2 as shown with the arrow yp1 in FIG. 3C. Then, the process shown in FIGS. 3A to 3C will be repeated. By this repetition, the HD area gets filled up with VOBUs as shown in FIG. 3D.

At times of performing the recording process, the continuous recording controlling unit 10 judges if the WP has reached the end of the HD area or not. When the WP has reached the end of the HD area as shown in FIG. 4A, the continuous recording controlling unit 10 puts the WP back at the start of the HD area as shown with the arrow yp2 in FIG. 4B, and then writes a VOBU stored in the track buffer 4 to an area located after the WP within the HD area as shown in FIG. 4C. When the WP has reached the end of the HD area, VOBU writing is performed after the WP is put back at the start of the HD area; therefore, some of the VOBUs that had previously been written to the HD get overwritten with newly generated VOBUs. As long as the MPEG encoder 3 keeps encoding broadcast signals, the recording process continues, and thus the continuous recording controlling unit 10 actualizes the continuous recording function. The point of time at which WP is put back at the start of the HD area from the end of the HD area is referred to as a “returning point”.

There is an exception in the overwriting process performed by the continuous recording controlling unit 10 when there is an area onto which a protective attribute is set. More specifically, when a protective attribute is set onto an area, the continuous recording controlling unit 10 writes VOBUs so as to avoid that area. This way, the data stored in the area having the protective attribute will be retained in the HD area semi-permanently, as long as the protective attribute does not get cancelled.

It is acceptable if the continuous recording process is performed on a specific broadcast channel determined by a user in advance. It may be arranged so that the channel to be recorded can be changed according to the operations performed by the user in the past. In this case, the recording apparatus needs to store the history of operations by the user every time the user operates. When the user instructs execution of the continuous recording function, the channel to be recorded continuously will be changed according to the history of channel operations inputted by the user some time in the past, like a week before or on the previous day. Thus, it is possible to record continuously different channels. Alternatively, it is also possible to automatically change channels at regular time intervals.

The time search table generating unit 12 obtains from the MPEG encoder 3 the size and reproduction controlling information of each VOBU, and generates a time search table in which the VOBU size is shown in correspondence with the VOBU reproduction controlling information, every time the MPEG encoder 3 generates a VOBU. By referring to this time search table, it is possible to access to any VOBU stored in the HD area with use of the time information.

The protective attribute setting unit 13 receives from the user an input of starting and ending times of a protective attribute, and converts these times into in-point and out-point addresses on HD area before writing them to the RAM 9b. This process of receiving the user's input is performed using one of the following three menus. The first menu is a GUI for receiving an input of dates and times such as month/day, hour/minute/second. The input concerning the protective attribute is indicated by the numerals for dates and times of the start and the end of the protective attribute. The second menu is a GUI for displaying a broadcast schedule which shows in graphics a plurality of broadcast programs that have been broadcasted between N hours ago and the current time. The protective attribute setting unit 13 receives the user operation concerning a protective attribute by receiving a selection out of the broadcast programs shown in graphics. The third menu is, being similar to the first menu, a GUI for receiving an input of a date and a time such as month/day, hour/minute/second. The third menu differs from the first menu in that numerals for the date and time of only the start of the protective attribute needs to be inputted.

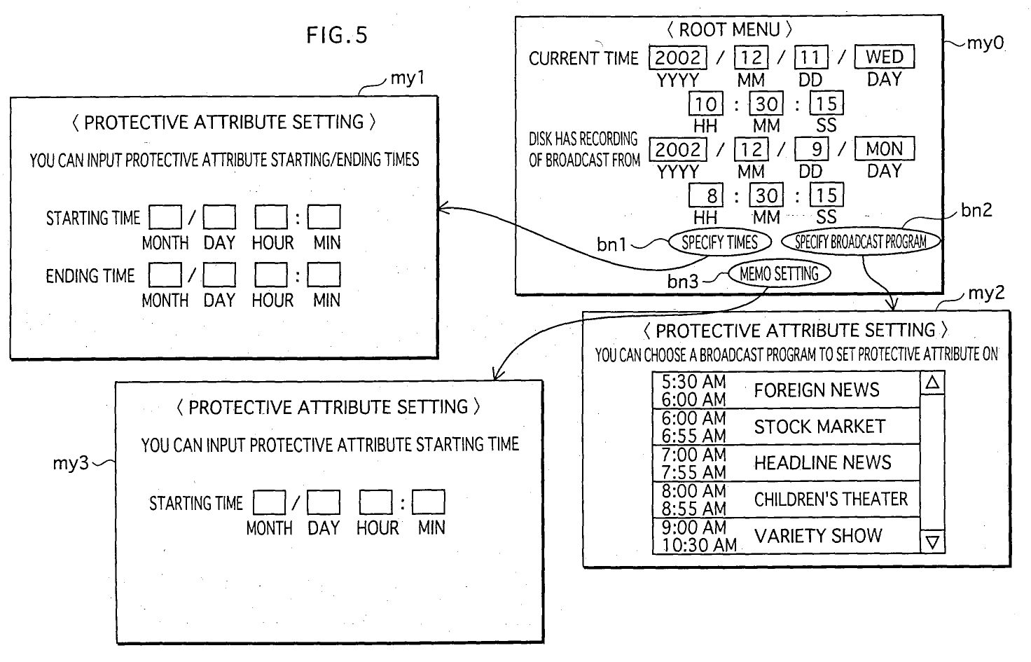

Examples of these three menus are shown in FIG. 5. The root menu shown in FIG. 5 shows that the HD area stores the broadcast of from what time to what time. FIG. 5 is on the supposition that the recording capacity N of the HD area is 50 hours, and the current time is 10 (H):30(M):15(S), Dec. 11, 2002. Thus, the root menu myO shows the user that the VOBUs of from 8:30:15, Dec. 9, 2002 to 10:30:15 Dec. 11, 2002 have been recorded onto the HD area. When one of the buttons in the root menu, bn1, bn2, and bn3 is pushed, one of the aforementioned three menus will be selectively displayed. The menu my1 is a GUI for receiving an input of dates and times such as day/month, hour/minute/second by receiving the numerals inputted into the boxes. The protective attribute setting unit 13 interprets the dates and times inputted in this menu as the start and the end of the protective attribute.

The menu my2 is a GUI for receiving an input concerning the protective attribute using a broadcast schedule. The broadcast schedule shows in graphics the broadcast programs in the past such as “Foreign News”, “Stock Market”, “Headline News”, “Children's Theater”, and “Variety Show”. These broadcast programs shown in graphics are GUI parts and have three states such as normal, focus, and active. The normal state denotes a state that the part is not selected by the user. The focus state denotes a state that the part is specified by an arrow key in a remote controller as a part to which a protective attribute is going to be set. The active state is a state that the part is confirmed to be a part to which a protective attribute is going to be set. When it has been confirmed with use of the remote controller which broadcast program is going to have a protective attribute, the protective attribute setting unit 13 converts the starting and ending times of the broadcast program into in-point and out-point addresses. The broadcast schedule is created from EPGs transmitted from broadcast stations and gets updated in due order as the broadcasts by the broadcast stations progress.

The menu my3 is a GUI for receiving an input of a date and a time such as day/month, hour/minute/second by receiving the numerals inputted into the boxes. The protective attribute setting unit 13 interprets the date and time inputted in this menu as the start of the protective attribute.

The following describes the continuous recording controlling unit 10 more in detail.

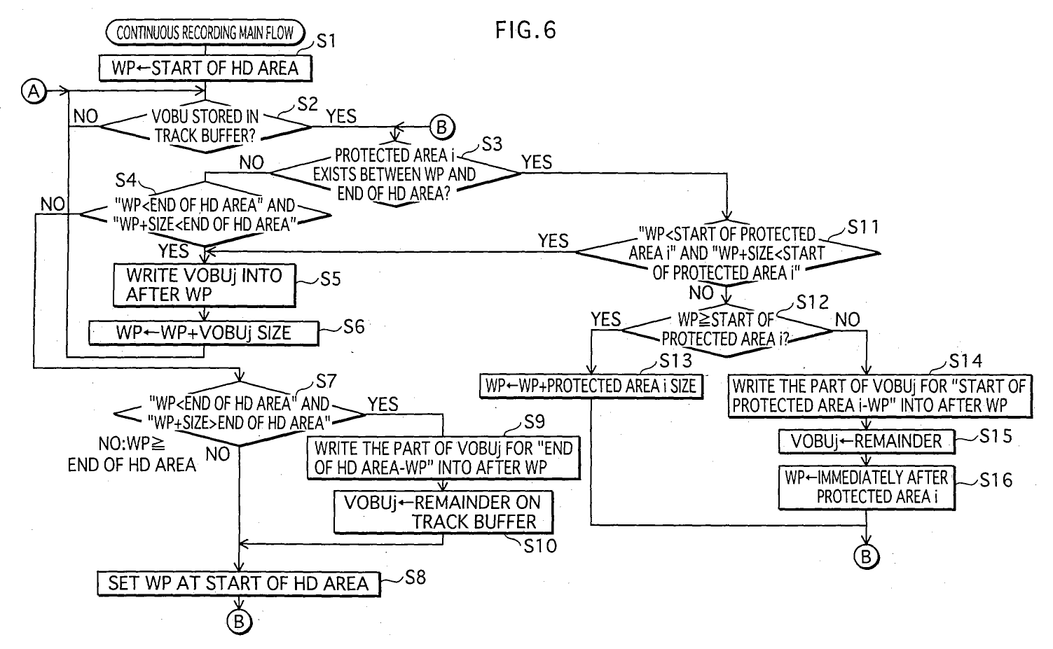

The continuous recording controlling unit 10 can be achieved by writing, in a computer description language, a computer program that executes the procedure shown in the flow chart of FIG. 6 and having the CPU read and execute it. The following describes in detail the process performed by the continuous recording controlling unit 10 with reference to the flowchart in FIG. 6. In the flow chart of FIG. 6, “VOBUj” denotes all or a part of the VOBUs stored in the track buffer 4, and “SIZE” denotes the size of a VOBU.

In the flow chart of FIG. 6, the WP is set at the start of the HD area first, and the process waits till a VOBU gets stored in the track buffer 4. When a VOBU gets stored (Step 2: Yes), the process proceeds to steps S3 and S4, and then the VOBUj gets written to an area located after the WP (Step S5), and the WP gets advanced for the size of the VOBU (Step S6), before the process returns to Step S2. This procedure gets repeated.

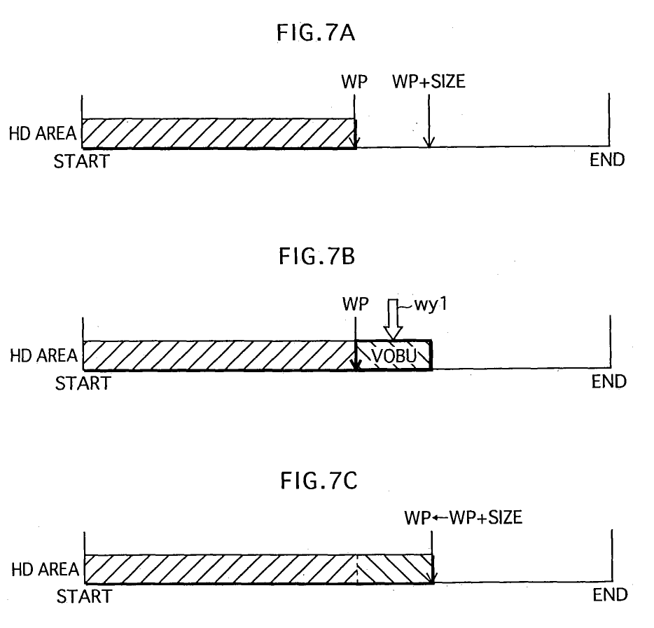

The procedure in Steps S2, S3, S4, S5, and S6 continues as long as the WP does not get obstructed by a protected area. FIG. 7A illustrates a VOBU writing in Steps S2 through S6. In FIG. 7A, there is nothing to obstruct the VOBU writing between the WP and “WP+SIZE”; therefore, a VOBU stored in the track buffer 4 gets written to an area located after the WP as shown in FIG. 7B, and the WP gets advanced for the VOBU size as shown in FIG. 7C. Subsequently, Steps S2 through S6 will continue to be executed as long as the situations illustrated in FIG. 7A through 7C apply. In Steps S3 and S4, it is judged whether the WP gets obstructed. When the judgment results in these steps are “Yes”, an exceptional process of updating the WP is performed, and the process returns to Steps S2 through S5.

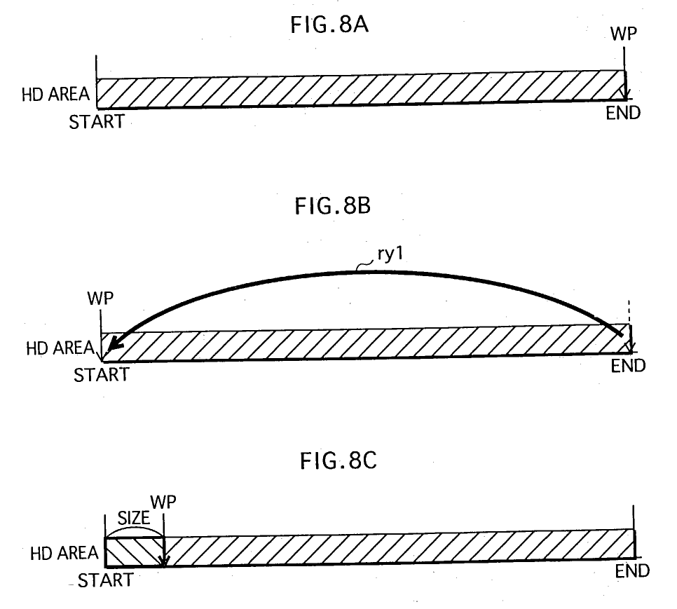

In Step S4, it is judged whether the WP has reached the end of HD area. When the WP has reached the end of HD area, a judgment is made in Step S7, and then, an exceptional process of updating the WP to the start of the HD area will be performed (Step S8), and the process returns to Step S3. FIG. 8A indicates a case where the judgment result is “Yes” in Step S4. As shown in FIG. 8A, when the WP has reached the end of the HD area, the WP is put back at the start of the HD area as shown with the arrow ry1 in FIG. 8B. Thus, a new VOBU is written to the start of the HD area as shown in FIG. 8C, and then the WP will be advanced by the size of this VOBU.

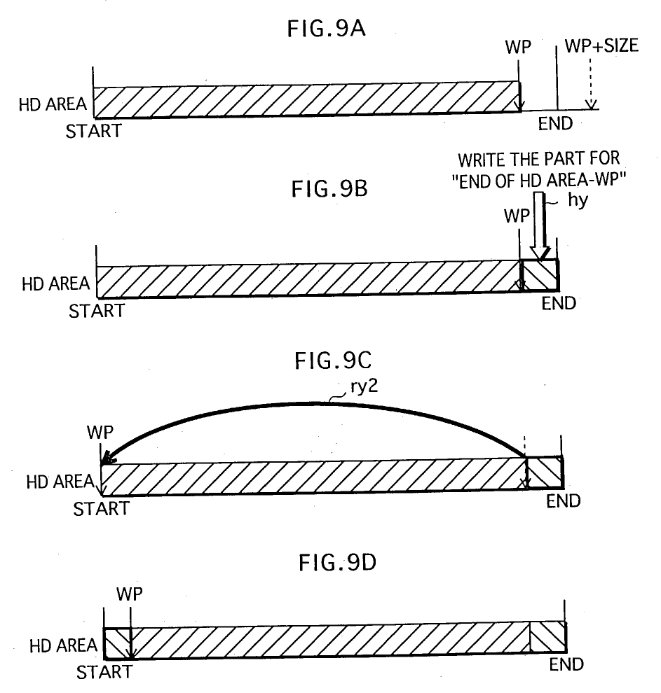

In Step S7, a judgment is made whether it is the case that the WP has not reached the end of the HD area, but the distance between the WP and the end of the HD area is too short to write the whole VOBU thereto. FIG. 9A shows the case where the judgment result of Step S7 is “Yes”. FIG. 9A illustrates a situation where the WP is located before the end of HD area, but the sum of the WP and SIZE, “WP+SIZE”, will be beyond the end of the HD area. In this case (Step S7), the part of VOBUj for “the end of the HD area WP” will be written to an area located after the WP so as to fill up to the end of the HD area, as shown with the arrow hy1 in FIG. 9B (Step S9), and after setting the remainder in the track buffer 4 as VOBUj (Step S10), the WP will be updated to the start of the HD area, as shown with the arrow ry2 in FIG. 9C (Step S8). Thus, as shown in FIG. 9D, this new VOBU is written to the start of the HD area, and the WP gets advanced by the size of this VOBU.

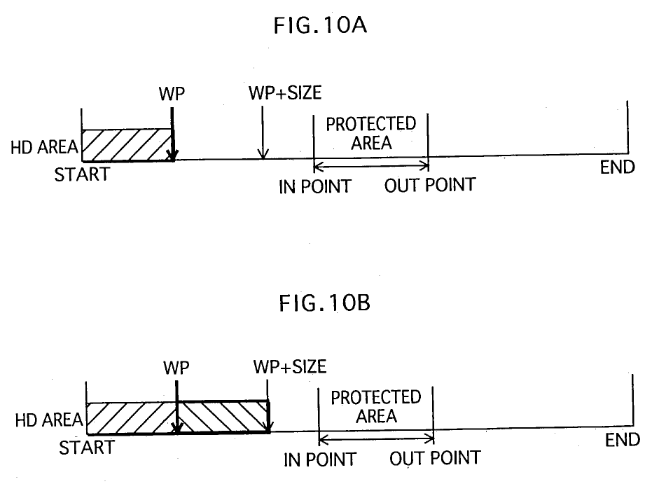

In Step S3, it is judged whether there is a protected area located after the WP. If there is a protected area, it is judged whether there is enough distance before the protected area for writing the whole VOBU thereto (Step S11) FIG. 10A illustrates a specific case where the judgment result of Step S11 is “Yes”. As shown in FIG. 10A, when the WP is located before the start of a protected area i, and also the sum of the WP and SIZE is before the start of the protected area i, the judgment result of Step S11 will be “Yes”. When there is enough distance before the start of the protected area, the process proceeds to Step S5 where the VOBU will be written as shown in FIG. 10B.

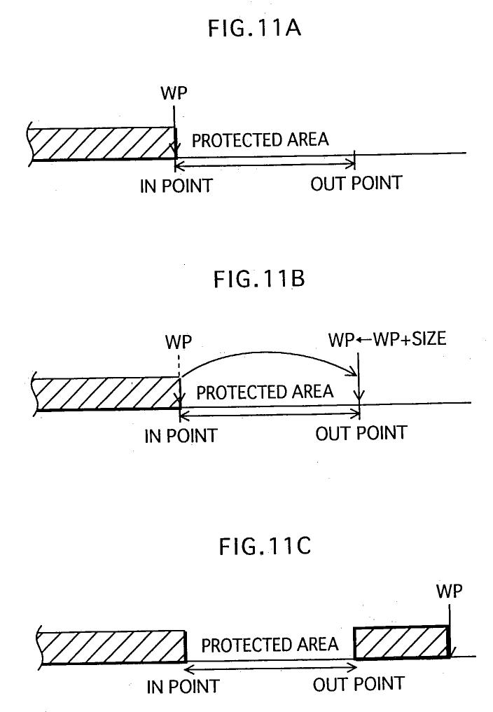

When the WP has reached the start of the protected area, an exceptional process of updating the WP so as to skip the protected area will be performed. This exceptional process means that it is judged whether the situation is the one shown in FIG. 11A, i.e. the WP has reached the start of the protected area (Step S12), and if the WP has reached it, then the size of the protected area i will be added to the WP so as to update the WP as shown in FIG. 11B (Step S13), and the process returns to Step S3.

This way, the new VOBU stored in the track buffer 4 is written to the area located after the protected area as shown in FIG. 11C.

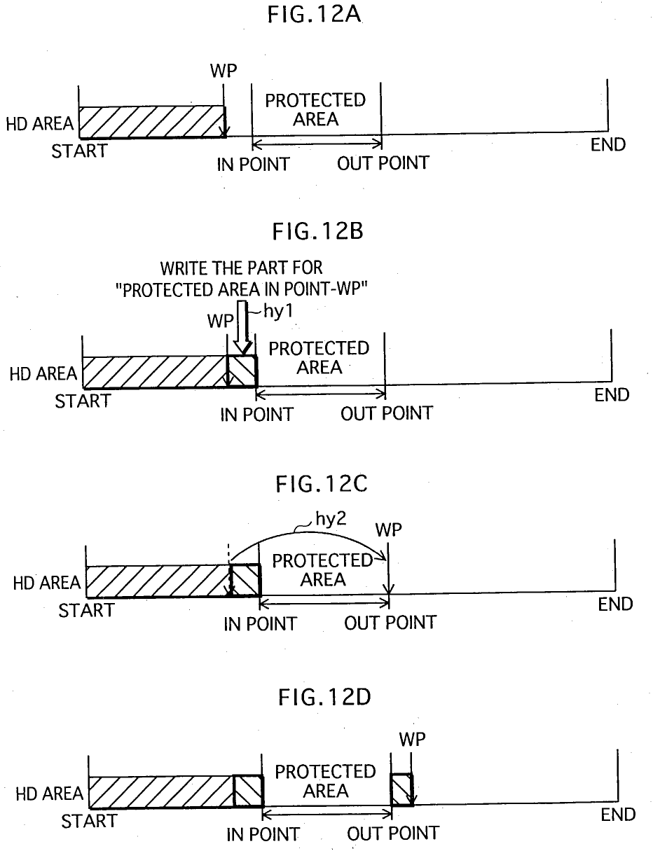

FIG. 12A illustrates a situation where the WP has not reached the start of the protected area, but the distance before the protected area is too short to write the whole VOBU thereto (Step S12: No). In other words, FIG. 12A shows a case where the WP is located before the start of the protected area, but “WP+SIZE” would be located after the start of the protected area. In such a case, some of the VOBU, i.e. the part of VOBUj for “the start of the protected area i−WP” will be written to an area located after the WP as shown with the arrow hyl in FIG. 12B, and the remainder will be set as a VOBU (Step S15). And then, an exception process will be performed so as to update the WP to the position immediately after the protected area as shown with the arrow hy2 in FIG. 12C (Step S16), and to return to Step S3. Thus, the remainder of VOBU in the track buffer 4 will be written to the area located immediately after the protected area.

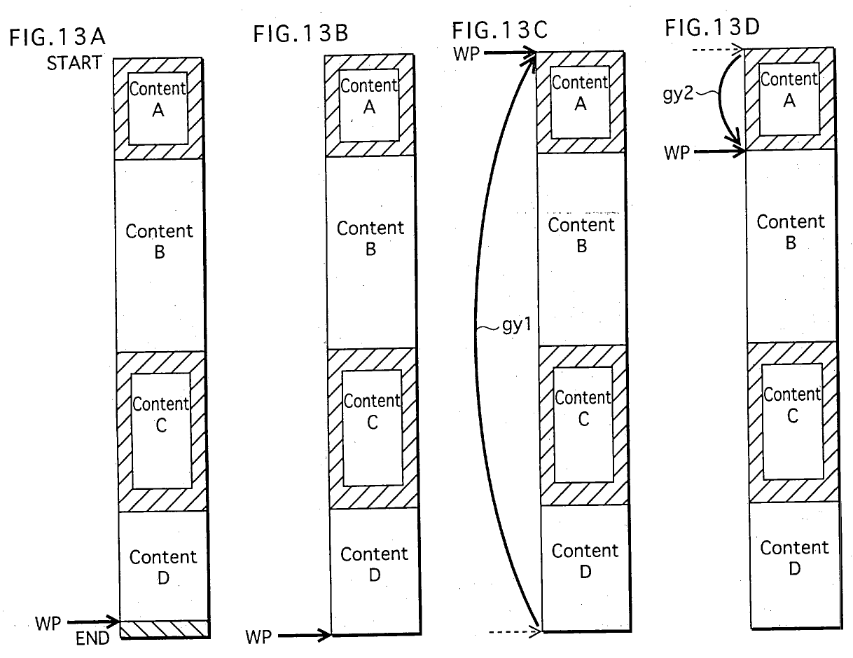

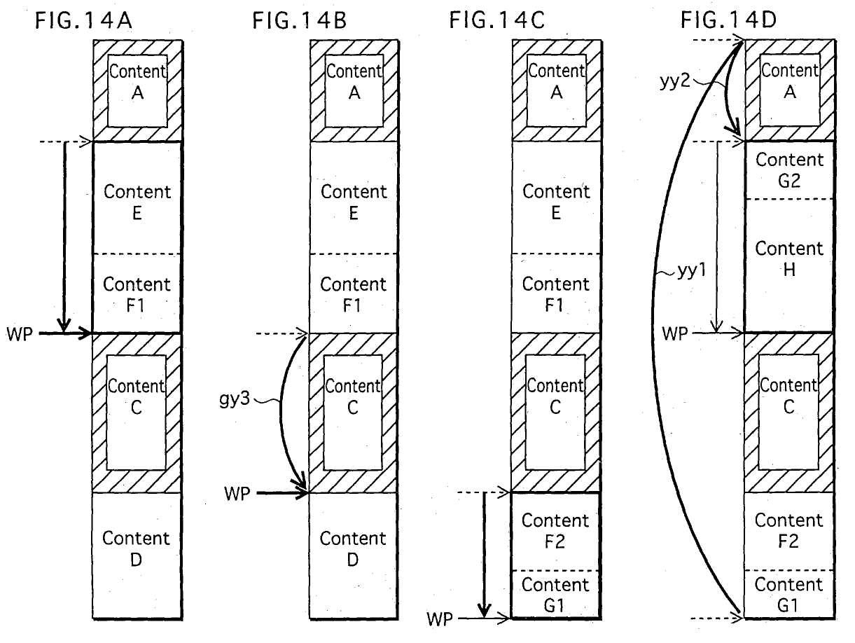

The process described in this flow chart will be explained in detail using the specific examples in FIGS. 13 and 14. FIG. 13A illustrates a situation where three broadcast programs “Content A”, “Content B” and “Content C” have already been written to the HD area, and the writing of “Content D” is under way. A protective attribute is set to each of Content A and Content C that have already been written. The last VOBU included in Content D is about to be written to the HD area, and that is why the WP is located a little before the end of the HD area in FIG. 13A.

When the last VOBU included in the Content D has been written, the WP reaches the end of the HD area as shown in FIG. 13B. At this time, the judgment results of Steps S3, S4, and S7 are “No”, and the process proceeds to Step S8, where the WP will be updated to the start of the HD area as shown with the arrow gy1 in FIG. 13C. It should be noted here that Content A recorded at the start of the HD area has a protective attribute set thereto. Since a protective attribute is set to the area in which Content A is recorded, the judgment result of Step S3 is “Yes” (a protected area exists ahead), the judgment result of Step S11 is “No” (not enough distance before the start of the protected area), and the judgment result of Step S12 is “Yes” (the WP is at the start of the protected area). The process then proceeds to Step S13 where the WP gets updated to the position immediately after Content A, as shown with the arrow gy2 in FIG. 13D. Located immediately after Content A is an area in which Content B is recorded, and the WP will be set at the start of Content B.

When the WP is set at the start of Content B, the judgment result of Step S3 is “Yes” (a protective attribute is set to Content C, which is located after Content B), and the judgment result of Step S11 is “Yes” (there is enough distance before Content C). The process then proceeds to Step S5 where the VOBU gets written. Consequently, the area in which Content B is recorded will be overwritten sequentially with VOBUs included in Content E; thereafter, the area in which Content B is recorded will be overwritten with Content E and the first portion of Content F (i.e. Content F1) until the WP reaches the start of Content C, as shown in FIG. 14A.

When the WP has reached the start of Content C, the judgment result of Step S3 is “Yes” (a protected area exists ahead), the judgment result of Step S11 is “No” (not enough distance before the start of the protected area), and the judgment result of Step S12 is “Yes” (the WP is at the start of the protected area). The process then proceeds to Step S13 where the WP is updated to the position immediately after Content C as shown with the arrow gy3 in FIG. 14B. Located immediately after Content C is an area in which Content D is written, and the WP will be set at the start of Content D.

When the WP is at the start of Content D, the judgment result of Step S3 is “No” (a protected area does not exist after Content D), the judgment result of Step S4 is “No”, and the process proceeds to Step S5 where a VOBU gets written. Consequently, the area in which Content D is written will be sequentially overwritten with VOBUs included in Content F; thereafter, the area in which Content D is recorded will be overwritten with the second portion of Content F (i.e. Content F2) and the first portion of Content G (i.e. Content G1) until the WP reaches the end of the HD area, as shown in FIG. 14C.

When the WP has reached the end of the HD area, the WP will be put back at the start of the HD area as indicated with the arrow yy1 in FIG. 14D, and the area in which Content A is recorded will be skipped as indicated with the arrow yy2; thereafter, the areas in which Content E and the first portion of Content F are recorded will be overwritten with the second portion of Content G and Content H.

The following describes the protective attribute setting unit 13 in detail.

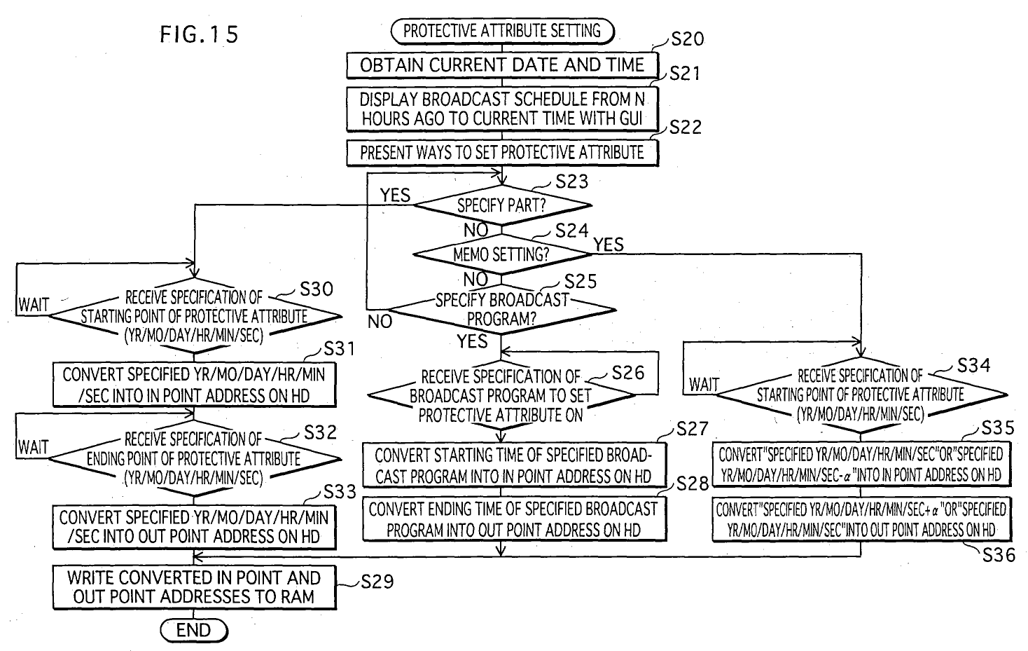

The protective attribute setting unit 13 can be actualized by writing, in a computer description language, the procedure shown in the flow chart of FIG. 15, and having the CPU execute it. The process of setting a protective attribute described in the flow chart of FIG. 15 can be performed through steps of obtaining the current date and time (Step S20), displaying the broadcast schedule from N hours ago to the current time with a GUI (Step S21), and displaying ways to set a protective attribute (Step S22). Subsequently, the process waits till one of the ways to set a protective attribute is selected (Steps S23 to S25) When the user chooses to set a protective attribute to an individual broadcast program (Step S25), a specification will be received as to which broadcast program in the program schedule should have a protective attribute set thereto (Step S26). Then, the starting time of the broadcast program specified will be converted into an in-point address on the HD (Step S27), and the ending time of the broadcast program specified will be converted into an out-point address on the HD (Step S28), before these addresses get written to the RAM 9b (Step S29).

At the time of conversion into an out-point address, when the recording of the broadcast program is not completed, the out-point address of the broadcast program will be set as the WP temporarily. When the recording of the broadcast program having the protective attribute is completed, the WP is confirmed to be the out-point address of the broadcast program.

When the user chooses to set a protective attribute by specifying a part of a broadcast program (Step S23: Yes), a specification will be received as to the starting point of the protective attribute (year, month, day, hour, minute and second) (Step S30), and then the specified year/month/day/hour/minute/second will be converted into an in-point address on the HD (Step 31), and another specification will be received as to the ending point of the protective attribute (year, month, day, hour, minute, and second) (Step S32), and then the specified year/month/day/hour/minute/second will be converted into an out-point address on the HD. (Step S33), before these addresses get written to the RAM 9b (Step S29).

When the user chooses to set a protective attribute by making a memo of a specific portion of a broadcast program (Step S24: Yes), a specification will be received as to the starting point of the protective attribute (year, month, day, hour, minute and second) (Step S34), and “the specified year/month/day/hour/minute/second” or “the specified year/month/day/hour/minute/second−α” will be converted into an in-point address on the HD (Step S35) Then, “the specified year/month/day/hour/minute/second+α ” or “the specified year/month/day/hour/minute/second” will be converted into an out-point address on the HD (Step S36), and the in-point and out-point addresses obtained from the conversion will be written to the RAM 9b (Step S29). It should be noted here that the reason why the point of time which is a predetermined length a before the specified yeat/month/day/hour/minute/second will be converted into an in-point address is because it is anticipated that users may feel needs for keeping on record some information that has just been broadcasted, for example, an address to be used for entering a prize contest, and so on.

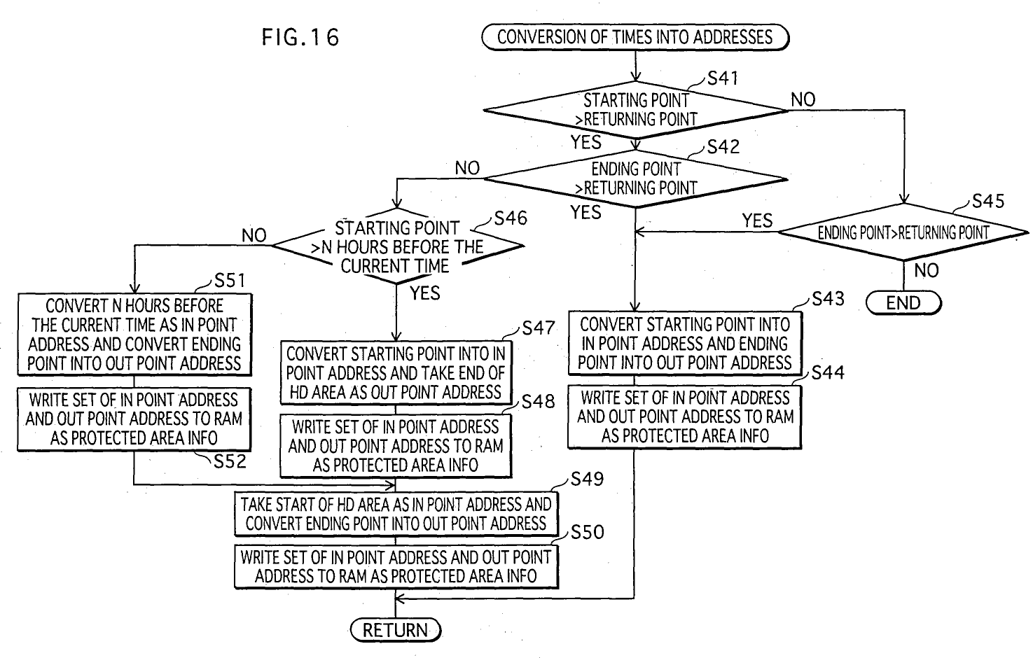

The process of converting the starting and ending points inputted by the user into addresses on the HD can be actualized by the sub-routine shown in the flow chart of FIG. 16. In Step S41, it is judged whether the starting point of the protected area is located after the returning point or not. In Step S42, it is judged whether the ending point of the protected area is also located after the returning point or not. When the judgment results of both of these steps are “Yes”, the starting point of the protected area will be converted into an in-point address, the ending point of the protected area will be converted into an out-point address (Step S43), and the set of the in-point address and the out-point address will be written to the RAM as protected area information (Step S44).

When the judgment result of Step S41 is “No”, in other words, when the starting point of the protected area is located before the returning point, it will be judged whether the ending point of the protected area is also located before the returning point (Step S45).

When both the starting and ending points are located before the returning point, the process proceeds to Step S43 where the starting point of the protected area will be converted to an in-point address, and the ending point of the protected area will be converted to an out-point address (Step S43), and the set of the in-point address and the out-point address will be written to the RAM as protected area information (Step S44).

When the starting point is located after the returning point, but the ending point is located before the returning point, it will be judged whether the starting point is before “N hours before the current time” (Step S46), and if the judgment result is “Yes”, two protected areas that share the returning point as a border will be set. The starting point of the protected area will be converted into an in-point address, and the end of the HD area will be taken as an out-point address (Step S47), and the set of the in-point address and the out-point address will be written to the RAM as protected area information (Step S48). In the same manner, the start of the HD area will be taken as an in-point address and the ending point of the protected area will be converted into an out-point address (Step S49), and the set of the in-point address and the out-point address will be written to the RAM as protected area information (Step S50).

When the starting point of the protected area is before “N hours before the current time”, the point N hours before the current time will be converted into an in-point address, and the ending point of the protected area will be converted into an out-point address (Step S51), and the set of the in-point address and the out-point address will be written to the RAM 9b as protected area information (Step S52), before the process proceeds to Step S49.

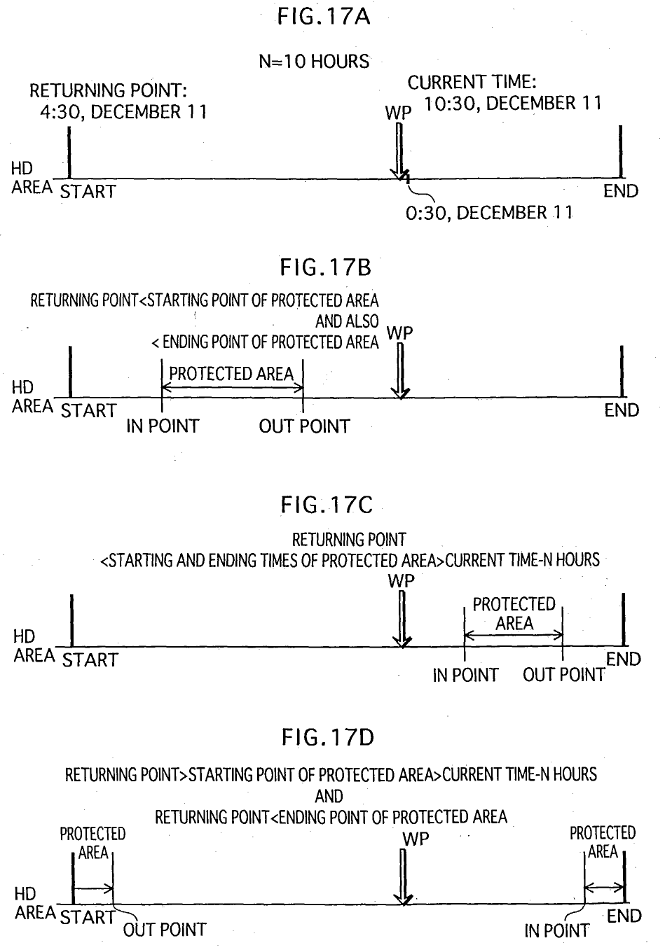

The following explains more in detail the process described in the flow chart in FIG. 17 with reference to specific examples. In the example shown in FIG. 17A, the current time is 10:30 on December 11 and N denotes 10 hours. The recording returned from the end of the HD area to the start at 4:30 on December 11.

In this situation, it is assumed that the starting and ending points of the protected area are set later than 4:30 on December 11, which is the returning point. In this case, since both the starting and ending points of the protected area are located after the returning points, the protected area is set by merely converting the starting point and the ending point of the protected area into addresses on the HD as shown in FIG. 17B.

On the other hand, in a situation where the starting and ending points of the protected area are set prior to 4:30 on December 11, both the starting and ending points of the protected area are located before the returning points, so the protected area is set by merely converting the starting point and the ending point of the protected area into addresses on the HD as shown in FIG. 17C.

In another case where the starting point of the protected area is set prior to 4:30 on December 11, and the ending point is set later than 4:30 on December 11, the protected area will be set as follows as shown in FIG. 17D: an area from the starting point of the protected area to the end of the HD area will be taken as one protected area, and another area from the start of the HD area to the ending point of the protected area will be taken as the other protected area.

As so far explained, according to the present embodiment, even if a user misses an opportunity to record a broadcast program, the broadcast program remains stored on a recording medium without being overwritten, until N hours of time elapses after the beginning of the broadcast (where N denotes a maximum time length of recording that the recording medium can store); therefore, the user is able to specify that the recording of a particular broadcast program should be retained even after the broadcast of the program has started. Since the specification of retaining the broadcast program can be made after the broadcast of the program has started, the user has time of N hours to make the specification, and the possibility for the user to be able to view the broadcast program will be higher.

Second Embodiment

In the first embodiment, the setting of a protective attribute is inputted by a user in terms of the schedule and numerals. In the second embodiment, the setting of a protective attribute will be received in connection with the reproduction process. More specifically, in the second embodiment, pushing the record key of a remote controller while the HD area is being reproduced will make it possible to set an protective attribute to the broadcast program being reproduced. Further, pushing the memo key of the remote controller will make it possible to set an attribute to an area starting with the current reproducing point to α hours later.

The characteristics of the second embodiment are represented by the reproduction controlling unit 11. In the second embodiment, the reproduction controlling unit 11 obtains a time stamp that defines the reproducing timing of each VOBU every time a VOBU is read from the HD area, and judges to which broadcast program each VOBU belongs. (The result of the judgment will be referred to as “the CURRENT program”.) The time stamp is time information indicating timing of displaying and decoding of a VOBU. By using a time stamp, it is possible to find out to which broadcast program a VOBU belongs.

In addition, the protective attribute setting unit 13 monitors whether the record key of the remote controller is pushed, and the menu key of the remote controller is pushed. When the key is pushed, a protective attribute will be set to the HD area. When a CURRENT program has finished being reproduced, and another broadcast program is about to be reproduced, the protective attribute setting unit 13 will make a pop-up dialogue for inquiring of the user whether a protective attribute should be set to the CURRENT program. If the user operates to express that a protective attribute should be set, a protective attribute will be set to the CURRENT program.

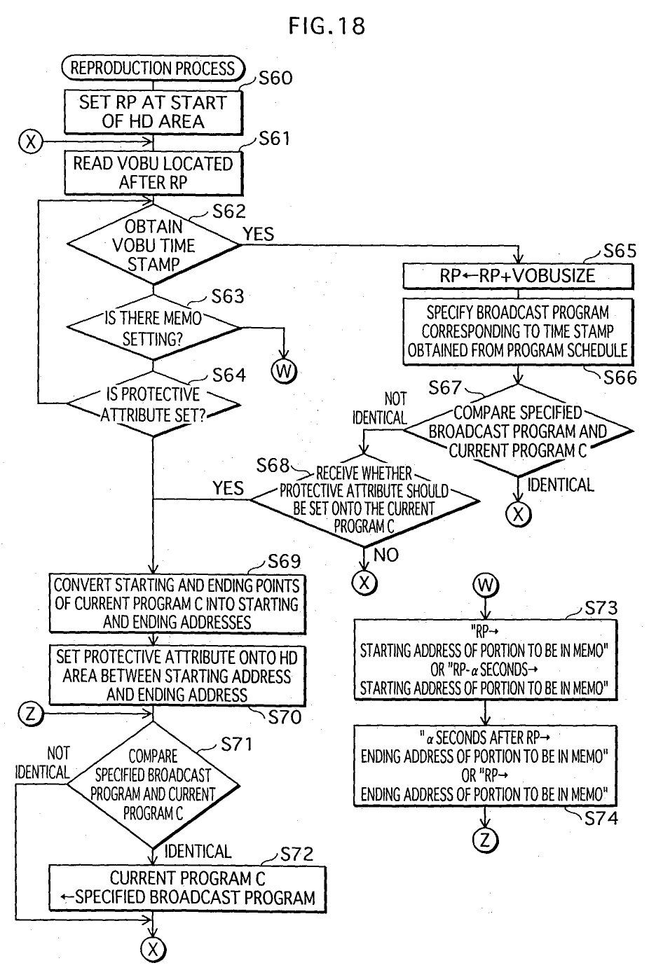

FIG. 18 is a flowchart showing the procedure in the process performed by the reproduction controlling unit 11 and the protective attribute setting unit 13 in the second embodiment.

In the reproduction process, an RP (reading pointer) will be set at the start of the HD area (Step S60), and the VOBUs located after the RP will be read (Step S61), and the process proceeds to the loop process made up of Steps S62 to S64. Step S62 is an event wait step where an event of the MPEG encoder 3's outputting a VOBU time stamp is waited for, and when the MPEG encoder 3 has outputted a time stamp specifying a VOBU, the RP will be advanced for the SIZE (Step S65), and a broadcast program will be specified according to a time stamp obtained from the program schedule (Step S66).

Subsequently, it is judged whether the specified broadcast program is identical to the CURRENT program (Step S67), and when it is identical, the process returns to Step S61.

After that, the process in Steps S61 to S67 will be repeated so long as VOBUs of one broadcast program are read. When the broadcast program specified in Step S66 is not identical to the CURRENT program, the process proceeds to Step S68 where it will be inquired of the user whether a protective attribute should be set to the CURRENT program C.

When the user replies in the affirmative that a protective attribute should be set (Step S68: Yes), the starting point and the ending point of the CURRENT program will be converted into an in-point address and an out-point address respectively (Step S69), and a protective attribute will be set between the in-point address and the out-point address on the HD area (Step S70). Subsequently, the specified broadcast program and the CURRENT program are compared (Step S71), and if they are identical, the specified broadcast program will be set as a CURRENT program C (Step S72), and the process will return to Step S61.

Also, when an operation for setting a protective attribute is performed during a reproduction (Step S64: Yes), the starting point and the ending point of the CURRENT program will be converted into an in-point address and an out-point address respectively (Step S69), and a protective attribute will be set between the in-point address and the out-point address on the HD area (Step S70). Subsequently, the specified broadcast program and the CURRENT program are compared (Step S71), and if they are identical, the specified broadcast program will be set as a CURRENT program C (Step S72), and the process will return to Step S61.

When the user selects a memo setting (Step S63: Yes), the process is as the following: either the RP or “the RP−α seconds” will be set at the in-point address of the portion of which a memo is to be made (Step S73); and, either “the address of the position located a seconds after the RP” or the RP will be set as the out-point address of the portion for the memo setting (Step S74). Then, the process proceeds to Steps S71 and S72. It should be noted here that the reason why the point of time which is a predetermined length a before the specified year/month/day/hour/minute/second will be converted into an in-point address is because it is anticipated that users may feel needs for keeping on record some information that has just been broadcasted without having it overwritten, for example, an address to be used for entering a prize contest, and so on.

When the broadcast program to which a protective attribute is to be set has not finished being recorded yet, the WP will be converted into an out-point address of the broadcast program, as mentioned before. In such a case, a problem will arise as below:

In a situation where a broadcast program which is longer than the capacity of the HD area is being recorded and the user sets a protective attribute to this broadcast program, the out-point address of the broadcast program will be set as the WP before the recording of the broadcast program is completed. Then, the WP keeps advancing past the end of the HD area and the start of the HD area, and reaches the in-point address of the broadcast program.

As mentioned before, because a protective attribute is set to this broadcast program, it is not possible to overwrite the part in the HD area in which this broadcast program has been recorded. It means that the HD area will be filled up with this broadcast program, and the continuous recording process will be discontinued.

In such a case, it would be preferable if the protective attribute setting unit 13 issues a warning to the user that a protective attribute should be set to a part of a broadcast program instead of an individual broadcast program.

As so far explained, according to the second embodiment of the present invention, while a broadcast program is being reproduced, a specification of whether a protective attribute should be set is received; therefore, setting protective attributes is convenient for the users.

Third Embodiment

In the first and the second embodiments, the recording apparatus is an HD recorder that has only HDD 5; however, in the third embodiment, explanation will be provided on a recording apparatus that has a DVD drive 14 in addition to an HDD 5.

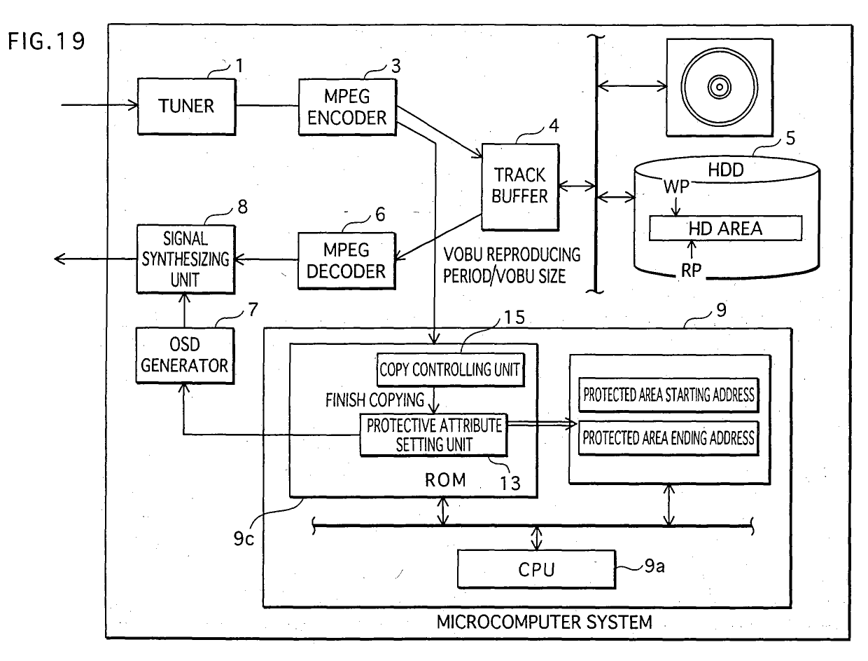

The recording apparatus that has a DVD drive 14 is called a hybrid recorder, and comprises an internal structure shown in FIG. 19. The recording apparatus in FIG. 19 differs from the one in FIG. 2 in that it comprises a DVD drive 14 and the copy controlling unit 15.

The DVD drive 14 is operable to load a DVD with a storage capacity of 4.7G bytes, and to perform reading and writing of the DVD. The DVD in this embodiment is a recordable DVD such as a DVD-RAM, a DVD-R, a DVD-RW, or a DVD+RW. The HD of the HDD 5 is built-in, whereas DVDs are portable and can be exchanged as necessary.

The copy controlling unit 15 makes a copy of one of the broadcast programs among N hours of recording stored on the HDD 5 onto the DVD in the track buffer 4.

When a broadcast program to which a protective attribute is set is copied onto a DVD, the protective attribute setting unit 13 of the third embodiment cancels the protective attribute set to the broadcast program recorded on the HDD 5 on the condition that the copying onto the DVD is completed. Since a back-up is obtained on the DVD through the copying, an opportunity of viewing the broadcast program is guaranteed to the user; therefore, it would not be of the user's disadvantage even if the protective attribute set to the broadcast program recorded in the HD area is cancelled. The area that stores the broadcast program whose protective attribute has been cancelled will serve as an area to be overwritten.

When it takes time to load a DVD, and a long time elapses before a DVD is loaded, the cancellation of the protective attribute in the HD area will be postponed; therefore, it is convenient for the users.

Even after the copying from the HD to a DVD is completed and the protective attribute is cancelled, the user is still able to reproduce the broadcast program from the HD until the WP reaches the area in which the broadcast program is recorded, and thus is able to operate with more facility. From this point of view, it is more convenient for the users.

As so far explained, according to the third embodiment, since the protective attribute to a broadcast program gets cancelled on the condition that the copying of the broadcast program from the HD to a DVD is completed, it is possible to alleviate excessive occupancy in the HD area by the broadcast program having a protective attribute.

Supplemental Information for the First to Third Embodiments

The embodiments so far explained are mere examples of systems which are expected to yield the most effective results in the current situation. The present invention may be modified within the scope of the gist of the invention. The following (A), (B), (C) and so on are some representative examples of modification:

(A) The recording apparatus in the first through third embodiments is a kind that is connected to the TV 101; however, it is also acceptable that the recording apparatus is incorporated into a liquid crystal display. Also, the recording apparatus in the first embodiment comprises the HD drive 5 and the MPEG encoder 3; however, it is acceptable that the recording apparatus is connected to them via IEEE1394 connector instead of comprising them. In addition, of the recording apparatus in all the embodiments, only the microcomputer system 9 which takes the main role in the recording process may be construed as the recording apparatus.

Since any of these recording apparatus is based on the invention described in the specification of the present application, no matter what mode is used, an action of manufacturing a recording apparatus on the basis of the internal structure of the recording apparatus described in the first through third embodiments is taken as an embodiment of the invention described in the specification of the present application. Actions of transfer, whether onerous (i.e. sales) or gratuitous (i.e. bestowal), lease, and import of the recording apparatus in the first through third embodiments are also construed as an embodiment of the present invention. Actions of offering such a transfer and a lease to public users through storefront displays and distribution of catalogues and brochures are also construed as an embodiment of the present invention.

(B) Information processing by the computer program shown in FIGS. 6, 15, 16, 18 is materially achieved with use of hardware resources such as a CPU, an MPEG encoder, and an HD drive. It means that the recording apparatus of the first through third embodiments can be structured through information processing performed by achieving means in which the computer program and the hardware resources collaborate, according to each purpose of usage.

Since the information processing by the computer program is materially achieved with use of the hardware resources, the computer program whose procedure is shown in the aforementioned flowcharts is construed as a creation of technical idea utilizing natural laws, and therefore the computer program by itself qualifies as an invention. In other words, the procedure shown in FIGS. 6, 15, 16, and 18 discloses a mode of embodiment of the computer program of the present invention.

Additionally, in the first through third embodiments, the computer program of the present invention is embodied as being incorporated in the recording apparatus; however, it is also acceptable to be embodied as being separated from the recording apparatus.

Embodiments of the computer program itself include (1) production of the computer program, (2) transfer of the computer program, whether onerous or gratuitous, (3) lease of the computer program, (4) import of the computer program, (5) providing the computer program for the public via bi-directional electronic communication lines, and (6) offering such a transfer and a lease of the computer program to public users through storefront displays and distribution of catalogues and brochures.

“(5) Providing the computer program for the public via bi-directional electronic communication lines” includes actions of transmitting the computer program for use by a user (program download service), and providing a user with functional features of the computer program via electronic communication lines while the computer program itself remains with those who provide it (ASP service with function provision).

(C) The “time” element of each of the steps chronologically executed in the flowcharts of FIGS. 6, 15, 16, 18 is considered as one of the essentials to specify the invention. Thus, the procedure in the flowcharts discloses a mode of using the recording method, and the flowchart itself is an embodiment of utilization of the recording method of the present invention. Needless to say, an action of executing the procedures described in the flowchart by chronologically executing the steps so as to achieve the object and obtain the operation and effects of the present invention is an embodiment of the recording method of the present invention.

(D) In the first through third embodiments, the recording medium with which the continuous recording process is performed has been explained as an HD; however, the physical characteristics of HDs do not contribute so much to the operation and effects of the present invention; it is therefore acceptable to use other recording media as long as they have capacities to record broadcast programs, e.g. optical discs such as CD-Rs, CD-RWs, and Blu-ray Discs. Magneto-optical discs such as PDs and MOs are also acceptable. Besides, semiconductor memory cards are also acceptable, e.g. SD Memory Cards, Compact Flash Cards, SmartMedia, MemorySticks, MultiMediaCards, andPCM-CIA Cards. Other acceptable examples include magnetic discs such as Flexible Discs, SuperDisks, Zip, and Clik! as well as removable hard disk drives such as ORB, Jaz, SparQ, Syjet, EzFlyer, and Microdrive.

(E) In the first to third embodiments, a video stream and an audio stream are multiplexed on a VOBU; however, it is also acceptable if multiplexed are sub-image streams in which subtitle texts are compressed with run-length encoding as well as other types of control information.

(F) For convenience sake, the continuous recording process has been explained as being performed using all of the HD area; however, it is acceptable to be performed using one of HD partitions.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A recording apparatus comprising:
a continuous recording unit operable to perform continuous recording and obtain broadcast contents broadcasted from N hours ago to a current time onto a recording medium; and
a setting unit operable to set a protective attribute onto a part of the recording medium according to a user operation, wherein
the broadcast contents are made up of a plurality of video units,
the continuous recording unit performs the continuous recording by (i) receiving a broadcast wave to obtain a new video unit, and (ii) overwriting one of the video units with the new video unit, and
the part of the recording medium having the protective attribute is protected against the overwriting performed by the continuous recording unit.

2. The recording apparatus of claim 1, further comprising
a pointer that indicates a location of writing in the recording medium, wherein
the continuous recording unit performs the overwriting by (i) writing the new video unit to the location of writing indicated by the pointer, and (ii) subsequently adding a size of the new video unit to the pointer, and
the protection against the overwriting is made by, when the pointer comes to a vicinity of the part having the protective attribute, adding an offset to the pointer so that the pointer skips this part.

3. The recording apparatus of claim 1, wherein
the part of the recording medium having the protective attribute stores therein two or more video units which represent one of a plurality of broadcast programs that have been broadcasted between N hours ago and the current time,
the recording apparatus further comprises
a display unit operable to display a schedule table of the plurality of broadcast programs, and
the user operation specifies a period during which the one of the plurality of broadcast programs is being broadcasted.

4. The recording apparatus of claim 1, wherein
the part of the recording medium having the protective attribute corresponds to a period, the period being a part of duration between N hours ago and the current time, and
the user operation is an input of a starting time and an ending time of the period.

5. The recording apparatus of claim 1, wherein
the user operation is an input of a starting time, and
the part of the recording medium having the protective attribute stores therein two or more video units which correspond to either (a) a predetermined length of time beginning at the starting time or (b) a predetermined length of time into past from the starting time.

6. The recording apparatus of claim 1, further comprising:
a loading unit operable to load a portable recording medium; and
a copying unit operable to copy, onto the portable recording medium, the part of the recording medium having the protective attribute.

7. The recording apparatus of claim 6, wherein
the part of the recording medium keeps having the protective attribute there on until the part finishes being copied onto the portable recording medium, at which time the protective attribute gets cancelled.

8. The recording apparatus of claim 1, wherein
the part of the recording medium having the protective attribute stores therein two or more video units which represent one of a plurality of broadcast programs that have been broadcasted between N hours ago and the current time,
the recording apparatus further comprises
a reproducing unit operable to reproduce each of the video units recorded on the recording medium, and
the setting unit, when each of the plurality of broadcast programs finishes being reproduced, inquires of the user whether or not a period corresponding to each broadcast program should be retained, and
the user operation is an affirmative reply in response to the inquiry.

9. The recording apparatus of claim 1, wherein
the part of the recording medium having the protective attribute stores therein two or more video units which represent one of a plurality of broadcast programs that have been broadcasted between N hours ago and the current time,
the recording apparatus further comprises
a reproducing unit operable to reproduce each of the video units recorded on the recording medium, and
the user operation indicates that a period corresponding to a broadcast program currently being reproduced should be retained.

10. A computer-readable program for having a computer execute recording processing, comprising:
a continuous recording step of performing continuous recording and obtaining broadcast contents broadcasted from N hours ago to a current time onto a recording medium; and
a setting step of setting a protective attribute onto a part of the recording medium according to a user operation, wherein
the broadcast contents are made up of a plurality of video units,
the continuous recording step performs the continuous recording by (i) receiving a broadcast wave to obtain a new video unit, and (ii) overwriting one of the video units with the new video unit, and
the part of the recording medium having the protective attribute is protected against the overwriting performed in the continuous recording step.

11. The computer-readable program of claim 10, further comprising
a pointer that indicates a location of writing in the recording medium, wherein
the continuous recording step performs the overwriting by (i) writing the new video unit to the location of writing indicated by the pointer, and (ii) subsequently adding a size of the new video unit to the pointer, and
the protection against the overwriting is made by, when the pointer comes to a vicinity of the part having the protective attribute, adding an offset to the pointer so that the pointer skips this part.

12. The computer-readable program of claim 10, wherein
the part of the recording medium having the protective attribute stores therein two or more video units which represent one of a plurality of broadcast programs that have been broadcasted between N hours ago and the current time,
the computer-readable program further comprises
a display step of displaying a schedule table of the plurality of broadcast programs, and
the user operation specifies a period during which the one of the plurality of broadcast programs is being broadcasted.

13. The computer-readable program of claim 10, wherein
the part of the recording medium having the protective attribute corresponds to a period, the period being a part of duration between N hours ago and the current time, and
the user operation is an input of a starting time and an ending time of the period.

14. The computer-readable program of claim 10, wherein
the user operation is an input of a starting time, and
the part of the recording medium having the protective attribute stores therein two or more video units which correspond to either (a) a predetermined length of time beginning at the starting time or (b) a predetermined length of time into past from the starting time.

15. The computer-readable program of claim 10, further comprising:
a loading step of loading a portable recording medium; and
a copying step of copying, onto the portable recording medium, the part of the recording medium having the protective attribute.

16. The computer-readable program of claim 15, wherein
the part of the recording medium keeps having the protective attribute thereon until the part finishes being copied onto the portable recording medium, at which time the protective attribute gets cancelled.

17. The computer-readable program of claim 10, wherein
the part of the recording medium having the protective attribute stores therein two or more video units which represent one of a plurality of broadcast programs that have been broadcasted between N hours ago and the current time,
the computer-readable program further comprises
a reproducing step of reproducing each of the video units recorded on the recording medium, and
the setting step, when each of the plurality of broadcast programs finishes being reproduced, inquires of the user whether or not a period corresponding to each broadcast program should be retained, and
the user operation is an affirmative reply in response to the inquiry.

18. The computer-readable program of claim 10, wherein
the part of the recording medium having the protective attribute stores therein two or more video units which represent one of a plurality of broadcast programs that have been broadcasted between N hours ago and the current time,
the computer-readable program further comprises
a reproducing step of reproducing each of the video units recorded on the recording medium, and
the user operation indicates that a period corresponding to a broadcast program currently being reproduced should be retained.
